(19) United States
(12) Patent Application Publication
(10) Pub. No.: US 2023/0307865 A1
(43) Pub. Date: Sep. 28, 2023

(54) ELECTRICAL CONNECTOR

(71) Applicant: FAURECIA SYSTEMES D'ECHAPPEMENT, NANTERRE (FR)

(72) Inventors: Thomas SOMMIER, BELFORT (FR); David ZAHND, VANDONCOURT (FR)

(21) Appl. No.: 18/123,378

(22) Filed: Mar. 20, 2023

(30) Foreign Application Priority Data
Mar. 22, 2022 (FR) 22 02535

(51) Int. Cl. H01R 13/52; H01R 13/50

(52) U.S. Cl. CPC H01R 13/5202; H01R 13/50

(57) ABSTRACT

The disclosure relates to an electrical connector comprising an electrical conductor, an electrical insulator surrounding the electrical conductor, and a housing surrounding the electrical insulator. A ring surrounds the electrical insulator, and is arranged in an extension of the housing, longitudinally at an end of the electrical insulator and longitudinally spaced from the housing by a length at least equal to one times a thickness of the electrical insulator.

### CROSS-REFERENCE TO RELATED APPLICATION

This application is a U.S. non-provisional application claiming the benefit of French Application No. 22 02535, filed on Mar. 22, 2022, which is incorporated herein by reference in its entirety.

### TECHNICAL FIELD

The disclosure relates to an electrical connector, suitable for being used, e.g. for producing an electrical through-wall connection, commonly called an electrode, for supplying current to an element of an exhaust line.

### BACKGROUND

As illustrated in FIG. 1, such an electrical connector 1 is used for connecting a mating connector 11 provided with a cable 15 for supplying electricity. For transmitting electricity, the connector 1 comprises a linear monopolar electrical conductor 2. The conductor 2 is substantially central. Same is comprises of an electrode which crosses through a metal wall 7 of an exhaust line so as to supply electricity to a piece of equipment arranged in an exhaust line, while being electrically insulated with respect to said metal wall 7.

An exhaust pipe carries the exhaust gases at the outlet of a heat engine. Same integrates different equipment for purifying exhaust gases along the length thereof. The electrode is more particularly designed for supplying a heating element, apt to heat the exhaust gases circulating in the exhaust line and the purification equipment, such as catalysts.

The conductor 2 is surrounded throughout the periphery thereof by a housing 4 in the zone surrounding the crossing through the metal wall 7. The substantially tubular housing 4 is typically made of metal and is rigidly attached to the metal wall 7 of the exhaust line through which the housing crosses in a sealed manner.

Since the wall 7 of the exhaust line is at the chassis ground potential, i.e. has a potential different from the potential of the conductor 2, an insulator 3 surrounding the conductor 2 is arranged between the conductor 2 and the housing 4.

The mating connector 11 comprises a monopolar electric mating conductor 12, substantially central with respect to the axis of the conductor 2, apt to come into contact with the conductor 2. The mating connector 11 further comprises a mating housing 14 surrounding the mating conductor 12. The mating housing 14 is commonly metallic and is in electrical contact with the mating conductor 12.

To prevent any risk of liquid being present between the connector 1 and the mating connector 11, mainly at the interface between the conductor 2 and the mating conductor 12, which could generate a leakage current or a short circuit between the first potential, common to the conductor 2, the mating conductor 12 and the mating housing 14 and the second, different, potential of the housing 4, the mating housing 14 is extended longitudinally so as to cover the longitudinal end 6 of the connector 1 by surrounding said end. Such conformation makes it possible to achieve a constriction resisting a penetration of liquid resulting from a projection.

The mating conductor 12 and the mating housing 14 can be two distinct parts or a single part.

Since the housing 4 is at a second potential, different from the first potential, such surrounding is necessarily produced without contact.

Thereby a delicate compromise arises between a space, too large, between housing 4 and the mating housing 14, carrying the risking of allowing a liquid to enter, and a space too small which carries the risk of generating a contact which could lead to a short-circuit or a proximity which could lead to a current leak due to deformation or a tolerance deviation.

One solution, as proposed by DE 102016209282, more particularly illustrated in FIG. 2, consists of stripping the insulator 3 by eliminating the housing 4 at the end 6 over a length sufficient to lengthen the creepage distance between the conductor 2 and the housing 4.

However, the end of the insulator 3, which is a more fragile material, at the end 6 left bare, tends to disintegrate.

### SUMMARY

In order to combat such disintegration, the disclosure proposes to add, at an end 6, a reinforcing ring 5, encircling the end of the insulator 3 in order to protect the insulator against such disintegration.

To this end, the disclosure relates to an electrical connector, comprising an electrical conductor, an electrical insulator surrounding the conductor, a housing surrounding the insulator and a ring surrounding the insulator, arranged in the continuation of the housing, longitudinally at the end of the insulator and spaced longitudinally from the housing by a length at least equal to one times the thickness of the insulator.

Particular features or embodiments, which can be used alone or in combination, are:
the ring is spaced longitudinally from the housing by a length at least equal to one and a half times, preferentially at least two times the thickness of the insulator,
the ring is made of metallic material, preferentially stainless steel, nickel chromium alloy or iron chromium aluminum alloy, or ceramic,
the insulator has a radial enlargement at the gap between the housing and the ring, so as to fill the gap between the housing and the ring,
at the gap between the housing and the ring, the longitudinal profile of the insulator is concave and external to the continuation of the profile of the housing,
the insulator is made of ceramic, glass, mica, alumina or magnesium oxide or any other electrically insulating and heat-resistant mineral material, preferentially resistant to at least 900° C.

In a second aspect, the disclosure relates to an assembly comprising a connector having the above features and an electrical mating connector connected to the connector, the mating connector comprising a substantially central linear monopolar electrical mating conductor in contact with the conductor and a mating housing surrounding the mating conductor, where a longitudinal end of the mating housing surrounds the ring, covering same longitudinally, at least partially.

Particular features or embodiments, which can be used alone or in combination, are:
the end of the mating housing is shaped so as not to touch the ring and forms a constriction limiting the access of liquids to the interface between the conductor and the mating conductor,
the end of the mating housing clamps the ring, preferentially in a liquid-tight manner.

In a third aspect of the disclosure, a heating element for an exhaust line, comprising at least one electrode, wherein said at least one electrode comprises, at the outer end thereof, such a connector.

### BRIEF DESCRIPTION OF THE DRAWINGS

The disclosure will be better understood upon reading the following description, given only as an example and making reference to the enclosed drawings, wherein:

FIG. 1 shows, in a profile section view, a connector according to a first prior art,

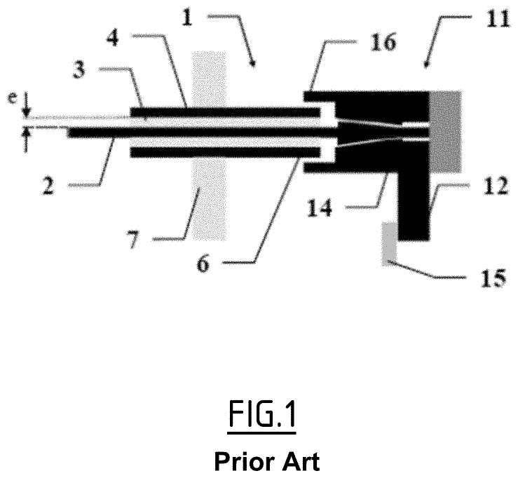

FIG. 2 shows, in a profile section view, a connector according to a second prior art,

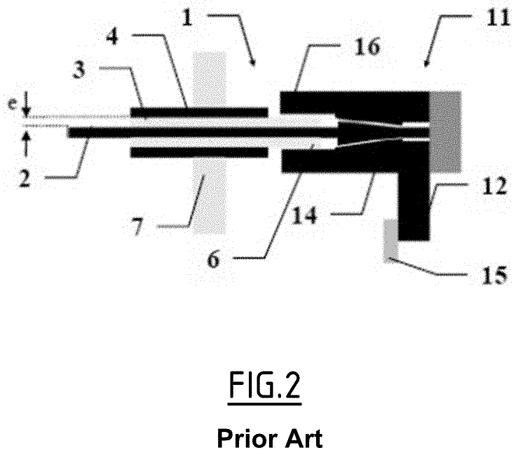

FIG. 3 shows, in a profile section view, a connector according to a first embodiment of the disclosure,

FIG. 4 shows, in a profile section view, a connector according to a another embodiment of the disclosure,

FIG. 5 shows a perspective view of a connector according to the disclosure,

FIG. 6 shows, in a profile section view, a connector according to a first embodiment of the disclosure,

FIG. 7 shows, in a profile section view, a connector according to a second embodiment of the disclosure,

FIG. 8 shows, in a profile section view, a connector according to a third embodiment of the disclosure,

FIG. 9 shows, in a profile section view, a connector according to a fourth embodiment of the disclosure, and

FIG. 10 shows, in a profile section view, a connector according to a fifth embodiment of the disclosure,

### DETAILED DESCRIPTION

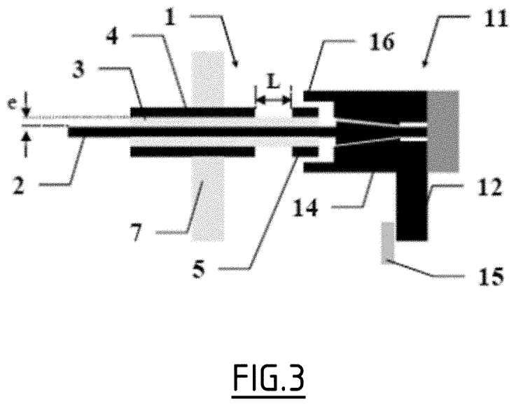

According to a first embodiment of the disclosure, illustrated in FIG. 3, the disclosure relates to an electrical connector 1. The connector 1 comprises an electrical conductor 2. The conductor 2 is preferentially monopolar and linear. Same is arranged substantially centrally with respect to the connector 1. An electrical insulator 3 is arranged all around and substantially all along the conductor 2. A housing 4 surrounds the insulator 3.

According to one feature, the connector 1 further comprises a ring 5. The ring 5 surrounds the insulator 3. The ring 5 is arranged in the continuation of the housing 4. Same is arranged substantially at the longitudinal end of the insulator 3. The arrangement thereof is such that the ring is longitudinally distant from the housing 4 by a length L. Said length L is at least equal to one times the thickness e of the insulator 3.

The housing 4 makes it possible to retain and to protect the insulator 3. In order to withstand the high heat which could be encountered in the vicinity of an exhaust line, the housing 4 is generally made of metallic material. Thus, the housing 4, in contact with the wall 7 of the exhaust line, is at the same potential as said wall 7, i.e. conventionally the vehicle chassis ground. The mating housing 14 is, for the same reasons, also made of metal. Same is in contact with the mating conductor 12 and thus at the same electrical potential as the mating conductor 12 and the conductor 2. Also, there should be no contact and even no proximity between the housing 4 and the mating housing 14. The ring 5 is at a distance from the housing 4 in order to prevent the ring 5 from being at the potential of the housing 4 or at chassis grounds. The above is required because the mating housing 14, according to the embodiment, either touches the ring 5 or might touch it.

According to another feature, the ring 5 is spaced longitudinally from the housing 4 by a length L at least equal to one and a half times, preferentially at least two times, the thickness e of the insulator 3, in order to further increase the protection, e.g. for safety reasons.

According to another feature, the ring 5 is made of a metallic or ceramic material. The metallic material is preferentially stainless steel, a nickel chromium alloy or an iron chromium aluminum alloy.

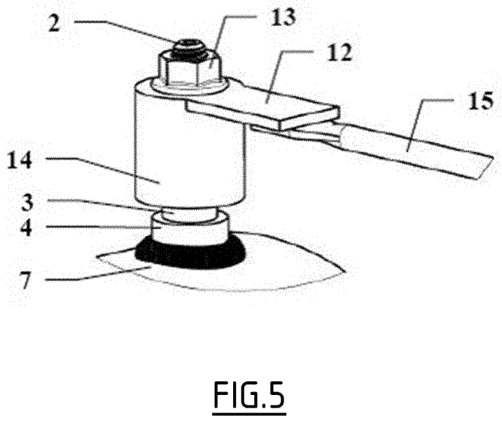

FIG. 5 illustrates, in a perspective view, a connector 1/mating connector 11 assembly connected together.

The ring 5 is similar, in terms of radial dimensions, to the housing 4, which same extends.

According to a first embodiment, more particularly illustrated in FIGS. 3, 6, 8, everything happens as if a longitudinal portion of the housing 4 had been cut and removed, e.g. by machining, forming the gap between the ring 5 and the housing 4. The insulator 3 retains the same cross-section and is exposed bare in the gap between the housing 4 and the ring 5.

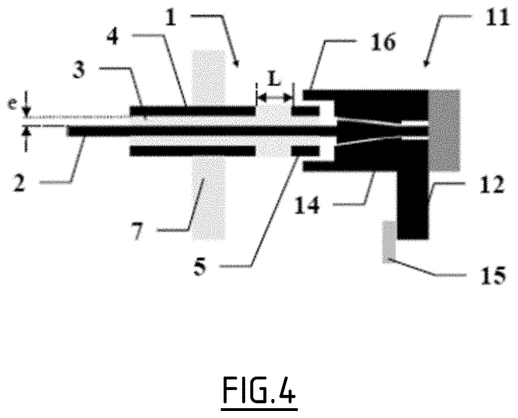

According to another embodiment, more particularly illustrated in FIGS. 4, 7, 9, the insulator 3 is increased to the level of said gap. Same has a radial enlargement at the gap between the housing 4 and the ring 5, so as to advantageously fill the gap between the housing 4 and the ring 5.

In the case of such a radial enlargement, the latter may be made of the same material as the insulator 3. Alternatively, same can be made of another material. Thus, e.g., the insulator 3 could be made of mica, whereas the radial enlargement filling could be made of glass.

As illustrated in FIGS. 4, 7, 9, the longitudinal profile of the insulator 3 can be straight, aligned along the extension and joining the external surfaces of the housing 4 and of the ring 5.

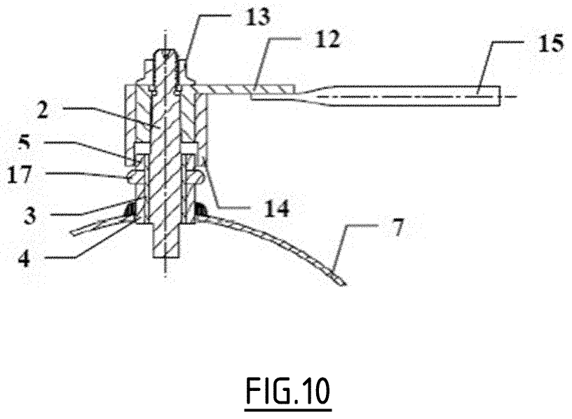

Alternatively, as illustrated in FIG. 10, the longitudinal profile of the insulator 3 can be outside the extension of the profile of the housing 4. The longitudinal profile of the insulator 3 is then preferentially concave, at the gap between the housing 4 and the ring 5. Such a concave profile 17 is advantageous in that the profile prevents a drop of liquid forming between the ring 5 and the housing 4. By capillarity, a drop could form between the ring 5 and the insulator protrusion or between the insulator protrusion and the housing 4. The protrusion can then provide a discontinuity of the drop.

It should be noted that ceramic-type materials can be hygroscopic. However, same can absorb water and thus generate a very low leakage current over a short length of such type.

According to another feature, the insulator 3 is made of ceramic, glass, mica or alumina or magnesium oxides or any other mineral material which is electrically insulating and resistant to heat. The application envisaged herein requires a resistance to a temperature of at least 900° C.

The disclosure further relates to an electrical mating connector 11, apt to connect with a connector 1, as described hereinabove. The mating connector 11 comprises an electrical mating conductor 12. The mating conductor 12 is preferentially monopolar. Same is arranged substantially centrally with respect to the mating connector 11. Same is apt to come into contact with the conductor 2. A mating housing 14 surrounds the mating conductor 12.

According to another feature, a longitudinal end 16 of the mating housing 14 is shaped so as to surround the ring 5, covering the ring longitudinally, at least partially.

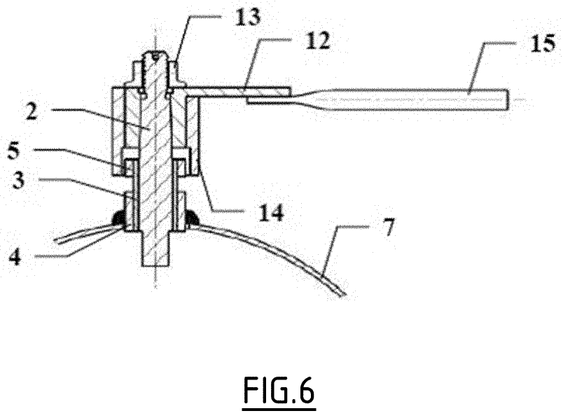

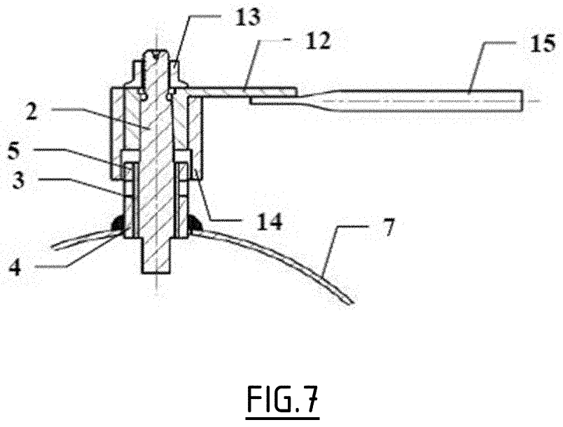

According to a first embodiment, more particularly illustrated in FIGS. 6 and 7, the end 16 of the mating housing 14 is shaped so as not to touch the ring 5. In such embodiment, together with the ring 5, the end 16 forms a constriction. Such constriction limits the access of liquids to the interface zone between the conductor 2 and the mating conductor 12. Such constriction comprises a very small gap. It is possible that such a gap fills with liquid by capillarity. However, the surface tension between the two contact surfaces of the liquid will confine the liquid to the interstitial zone and will not advance towards the inside of the connector 1.

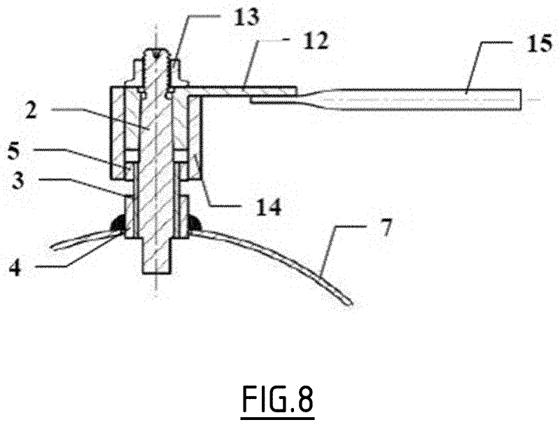

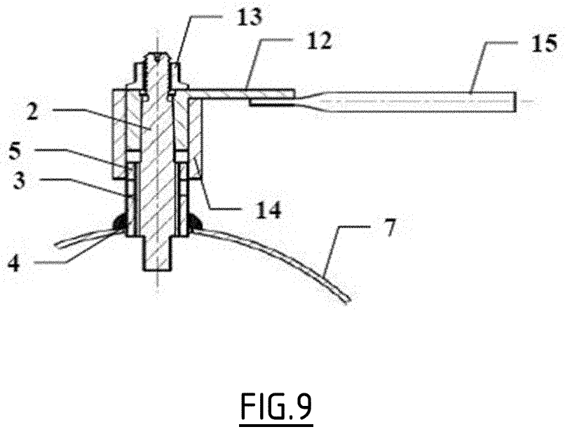

According to another embodiment, more particularly illustrated in FIGS. 8 and 9, the end 16 of the mating housing 14 is shaped so as to clamp the ring 5, preferentially in a liquid-tight way. The above can be achieved by a tight fit between the end 16 of the mating housing 14 and the ring 5. Alternatively, the end 16 of the mating housing 14 can be elastically deformable so as to fit, preferentially with clamping, around the ring 5.

Because of the clamping, contact is created between the mating housing 14 and the ring 5. It follows therefrom that the ring 5 is at the potential of the conductor 2 and of the mating conductor 12. Thus, the risk of current leakage between the ring 5 and the housing 4 increases. Also, in such embodiment, the distance 1 between the ring 5 and the housing 4 is preferentially increased. In such embodiment, the ring 5 is spaced longitudinally from the housing 4 by a length L at least equal to two times the thickness e of the insulator 3.

The disclosure further relates to a heating element for an exhaust line, comprising at least one electrode, wherein said at least one electrode comprises, at the outer end thereof, such a connector 1.

The disclosure has been illustrated and described in detail in the drawings and the preceding description. Same should be considered as illustrative and given as an example and not as limiting the disclosure to said description alone. Many variants of embodiment are possible.

### LIST OF REFERENCE SIGNS

1: connector,
2: conductor,
3: insulator,
4: housing,
5: ring,
6: connector end,
7: wall
11: mating connector,
12: mating conductor,
13: nut,
14: mating housing,
15: cable,
16: end of mating housing,
17: concave profile,
e: thickness,
L: length of the interval

1. An electrical connector, comprising:
an electrical conductor;
an electrical insulator surrounding the electrical conductor;
a housing surrounding the electrical insulator; and
a ring surrounding the electrical insulator, arranged in an extension of the housing, longitudinally at an end of the electrical insulator and longitudinally spaced from the housing by a length at least equal to one times a thickness of the electrical insulator.

2. The electrical connector according to the claim 1, wherein the ring is spaced longitudinally from the housing by a length at least equal to one and a half times the thickness of the insulator.

3. The electrical connector according to the claim 1, wherein the ring is made of a metallic material.

4. The electrical connector according to the claim 1, wherein the electrical insulator has a radial enlargement at a gap between the housing and the ring, so as to fill the gap between the housing and the ring.

5. The electrical connector according to the claim 4, wherein, at the gap between the housing and the ring, a longitudinal profile of the electrical insulator is concave and external to the extension of the longitudinal profile of the housing.

6. The electrical connector according to the claim 1, wherein the electrical insulator is made of ceramic, glass, mica, alumina or magnesium oxide or any other electrically insulating and heat resistant mineral material.

7. An assembly comprising the electrical connector according to claim 1 and an electrical mating connector connected to said electrical connector, the electrical mating connector comprising an electrical mating conductor in contact with the electrical conductor and a mating housing surrounding the electrical mating conductor, and wherein a longitudinal end of the mating housing surrounds the ring, covering the ring longitudinally, at least partially.

8. The assembly according to claim 7, wherein the longitudinal end of the mating housing is shaped so as not to touch the ring and forms a constriction limiting access of liquids to an interface between the electrical conductor and the electrical mating conductor.

9. The assembly according to claim 7, wherein the longitudinal end of the mating housing clamps the ring.

10. A heating element for an exhaust line, comprising at least one electrode that comprises, at an outer end thereof, the electrical connector according to claim 1.
